(19) United States
(12) Patent Application Publication
(10) Pub. No.: US 2007/0011687 A1
(43) Pub. Date: Jan. 11, 2007

(54) Inter-process message passing

(75) Inventors: Adnan Ilik, Redmond, WA (US); Adrian Marinescu, Issaquah, WA (US); Genevieve Fernandes, Redmond, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/177,126

(22) Filed: Jul. 8, 2005

(51) Int. Cl. G06F 9/46

(52) U.S. Cl. 719/313

(57) ABSTRACT

The number of copies of a message to be transferred from one process to another process in a computer where each process has a differing address space may be reduced through the use of a message-passing data structure. The sending process generates an operating system service call to copy the message to be transferred into the message-passing data structure. The receiving process need not generate a system service request to the kernel in order to retrieve the sent message and also does not require an additional copy of the transferred message to be made by the kernel, in order to read the message content. The data structure permits a mapping of the message into the address space of the receiving process as well as the address space of the kernel. The inter-process mechanism for exchanging messages provides proper flow control, synchronization, and security when two processes exchange data.

### BACKGROUND OF THE INVENTION

Inter-process communication mechanisms usually requires capturing the content of the message being send from a transmitting process in a first address space to a temporary buffer which is then copied by the receiving process into the second address space. Sending and receiving messages usually implies a significant performance cost due to the overhead associated with transitioning from a user mode in an application to kernel mode in an operating system along with the overhead association with operations to queue and de-queue messages.

FIG. 1 depicts a prior art system 100 where user mode application processes A and B interact with kernel mode operating system facilities to pass messages between the two processes. In a normal mode of operation, when process A 110 sends a message to process B 120, the message is first written into the user mode process A send buffer 115. Then the message is copied a first time from the user-mode send-buffer 115 to a kernel mode buffer 130. This copy is initiated upon a system service call invoked by process A 110. Some time later, when process B 120 calls the receive system service, the message data is copied a second time from the kernel mode buffer 130 into the receive buffer 125. Thus, in order to transfer a message from Process A 110 to Process B 120, two system service calls must be made and two copy operations must be performed.

For example, in the MS Windows® NT operating system developed by Microsoft® in Redmond, Wash., each process has its own address space as described by per-process memory management structures such as a page table hierarchy. The address space is divided into two regions; a user range, which is present per-process and accessible by both the user and kernel mode code, and the kernel range, which is global and accessible only by kernel mode code. The kernel mode code on each processor has access to only one user range as determined by the active page table hierarchy at any given time. So, in order to copy data between buffers from two separate processes, the data first needs to be copied to an intermediary kernel buffer and then copied to the target process.

This double copying of data has a significant performance cost both in terms of CPU cycles and cache utilization; especially for large buffers. Additionally, the MS Windows® NT shared memory infrastructure memory manager provides this mechanism to share data between two processes, but does not provide a flow control mechanism to ensure safe data exchange. An improvement in data transfer is therefore desirable.

### SUMMARY

An aspect of the invention includes a method to reduce the number of copies necessary in order to transfer a message from one process to another process in a computer where each process has a differing address space. To use the invention a receiving process must provide a buffer that the kernel will additionally map into the system address space, that the receiving process can use to receive messages. The message transfer involves the sending process generating a regular operating system service call to send a message. In the presence of a double mapped buffer at the receiving end the kernel copies the message into the message-passing data structure. Although the message transfer involves the operating system kernel, the receiving process need not generate a system service request to the kernel in order to retrieve the sent message. The data structure permits a mapping of the message into the address space of the receiving process and the address space of the kernel. In an aspect of the invention, queuing new messages and retrieving messages may occur without incurring costly operations in the operating system kernel mode. This is useful for cases where high rates of message or auxiliary information passed along with the messages may occur between multiple processes. The solution consists in a series of non-blocking operation to manipulate the message passing data-structure, that can be used simultaneously from both user and kernel side. The inter-process mechanism for exchanging messages provides proper flow control, synchronization, and security when two processes exchange data.

### BRIEF DESCRIPTION OF THE DRAWINGS

In the drawings:

FIG. 1 is an example prior art system for transferring messages between two processes;

FIG. 2 is an example message exchange system according to aspects of the invention;

FIG. 3 is an example data structure according to aspects of the invention;

FIG. 4a is an example flow diagram according to aspects of the invention;

FIG. 4b is an example flow diagram according to aspects of the invention;

FIG. 4c is an example flow diagram according to aspects of the invention;

FIG. 4d is an example flow diagram according to aspects of the invention; and

FIG. 5 is a block diagram showing an example computing environment in which aspects of the invention may be implemented.

### DETAILED DESCRIPTION OF ILLUSTRATIVE EMBODIMENTS

Exemplary Embodiments

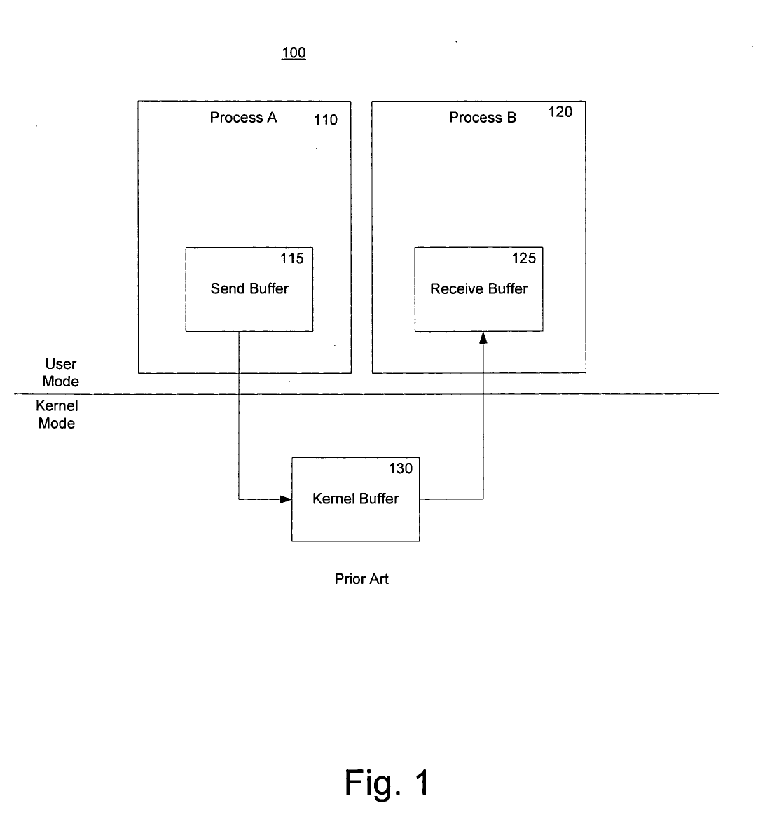

In one embodiment of the present invention, a MS Windows® NT memory manager provides an interface for a user mode process to provide a buffer and request the kernel to probe and lock down this buffer, map them into the kernel range of the address space and associate it with the receiving endpoint of the connection. These buffers and mapping are referred to as a completion list. The present invention may use this interface to probe, lock down, and map completion lists. The double mapping of the completion lists allows direct copying of data from the sender process's send buffer into the completion list without an intermediary kernel buffer as shown in FIG. 1. The double mapping also allows the receiver process, that has registered the completion list with the kernel, to pick up messages directly without having to make a system service call. In this environment, the receiving end enables the use of the message passing data structure, i.e. completion list, by supplying a buffer that the kernel will double map and thus informing the kernel that all incoming messages are to be received in the buffer.

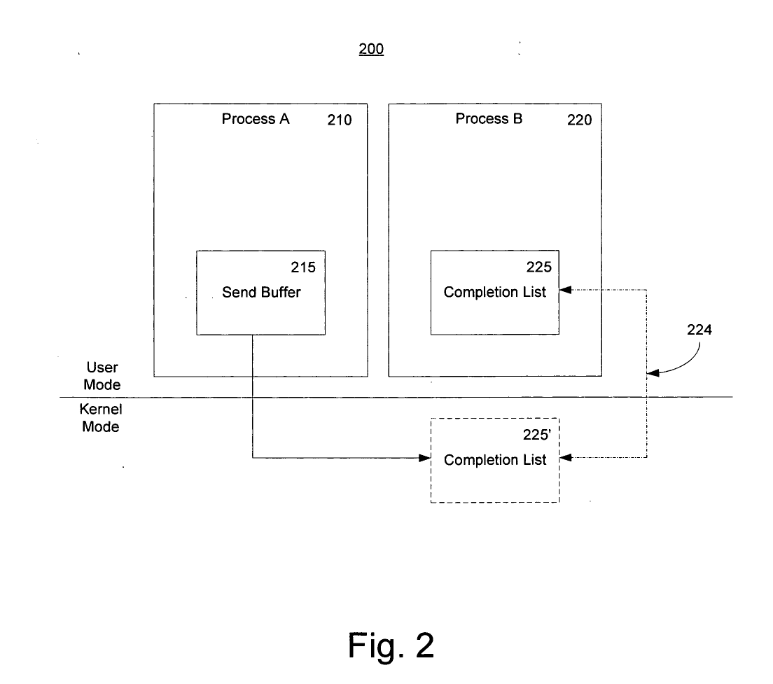

FIG. 2 depicts an example system 200 that provides for the transfer of messages between two processes in a user mode using facilities in the kernel mode without double copying of the message. It is assumed that process A 210 has a message to send to process B 220. Both processes represent a user mode, for example, one or more applications. Both processes utilize different address spaces. That is, each process uses a different set of page tables, each page table having a different virtual address to physical address translation set. Process A 210 writes the message into a send buffer 215 and then generates a system call to the kernel mode which may be an operating system. The configuration of FIG. 2 represents an “inbox” mode. This mode is requested by the receiver side, process B (220). The use of the completion list 225 is transparent to the sender side, process A (210).

Upon receipt of the system service call, the kernel mode copies the contents of the send buffer 215 into a completion list 225′. The completion list 225′ is a data structure which maps a copy of the message from the send buffer 215 into a set of physical pages. The physical pages of the completion list 225′ are mapped 224 to both the user and the kernel ranges of the address space. Accordingly, two views of the physical address space representing the completion list are visible. A completion list 225′ is visible by the kernel and the completion list 225 is visible by the target process B 220.

As a result of the use of the completion list 225′ data structure and its mapping 224 into a physical address range 225 available to process B 220, process B 220 does not have to copy the message from a kernel buffer 130 as in FIG. 1. Also, process B 220 does not have to make a system call to the kernel as in the configuration of FIG. 1 to access the message. Instead, process B reads the message using the completion list 225 in its own address space without a system service call or a second copy into its own address space. Essentially, process B 220 has access to the data once the message is fully placed into the completion list data structure.

In another aspect of the invention, multiple processes, wishing to communicate with Process B not shown in FIG. 2, can provide messages to completion list registered by Process B. As a result, process B can obtain multiple messages from multiple sources using a completion list.

In another aspect of the invention (with process B as the sender of the message(s) and process A as the receiver of the message(s)), process B can use a different completion list as an “outbox” and provide messages to the kernel. This aspect is a direct result of the mapping 224 of the completion list into both the user mode space of process B and the kernel mode space of an operating system. Thus, a message placed into the completion list 225 by process B may be viewed by the kernel mode without a call to or from the user mode and without a copy operation from the user to the kernel. In one embodiment of the invention, the sender or receiver registers a completion list for the purpose for which it wishes to use it; as an inbox or an outbox. Generally, a separate completion list is used for each purpose. A process can register two completion lists and use them simultaneously; an inbox for the express purpose of receiving message from processes, and an outbox for the express purpose of sending messages to other processes.

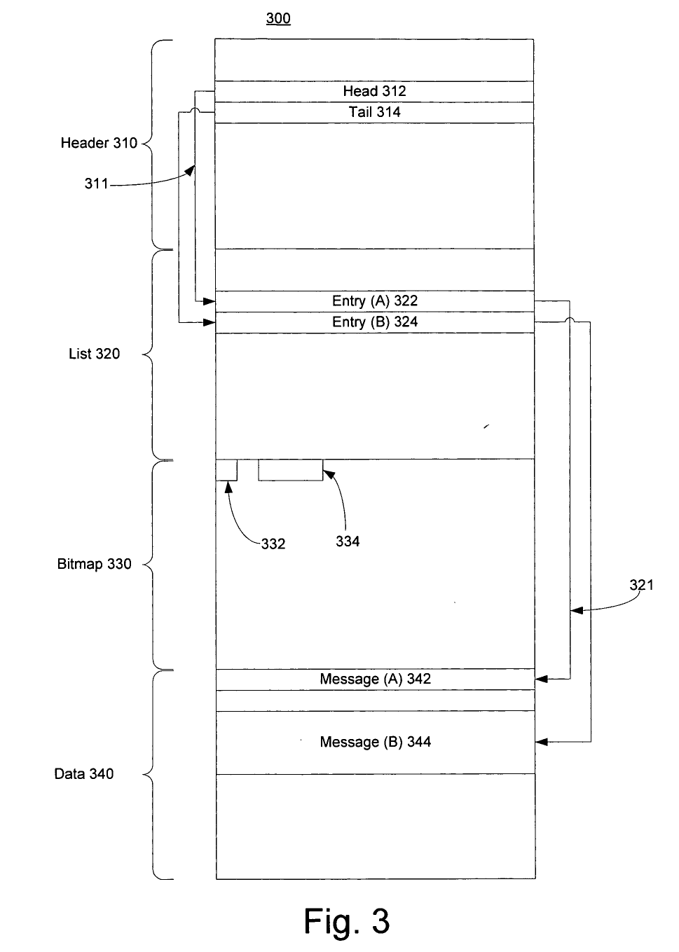

FIG. 3 depicts a data structure 300 for the completion list 225′, 225 described with reference to FIG. 2. The completion list data structure 300 of FIG. 3 includes a header field 310, a list field 320, a bitmap field 330 and a data field 340. The header field 310 contains basic information about the completion list including head 312 and tail 314 pointers referencing the list field 320. The list field 320 contains fixed size message entries having indexes for the actual message data field 340. The bitmap field 330 maintains an indication of the active or free memory space state for data blocks in the data field 340.

According to an aspect of the invention, some fields of the message-passing data structure 300 reference other fields of the same data structure. For example, the head field 312 references, via link 311, entry (A) 322 and the tail field 314 similarly references entry (B) 324. Entry (A) 322 contains an index which references, via link 321, message (A) 342 which may be of variable length. Entry (B) 324 likewise is indexed to message (B) 344. Any message in data field 340 may be of variable size. To prevent an overlap of message content, bitmap field 330 provides a representation of the size of the messages. For example, message (A) 342 is represented in the bitmap 330 as being a block 332 of a size proportional to the size of message (A) 342. Likewise, message (B) 344 is represented in the bitmap 330 as being a block 334 of a size proportional to the size of message (B) 344. The bitmap field 330 is useful when new messages are placed into the data structure 300. Examination of the bitmap field 330 allows a determination of where a new message will fit into the available data field 340 without overwriting other messages. This allows a variable sized message to be accommodated.

As an aspect of the present invention, synchronization of operation is provided. In one embodiment, all completion list data structure 300 indices and bitmaps are modified with atomic operations supported by the hardware and no additional synchronization primitives are used for user & kernel mode coordination. That is, the operating system kernel-mode code will never wait for a user-mode operation. This feature may be termed a non-blocking operation.

In one aspect of the invention, all operations done with the completion lists are non-blocking operations. A non-blocking operation is one which never forces a thread into a wait state and guarantees that at least one thread makes progress. For example, queueing a new message, retrieving a message and releasing the memory of a message after it was consumed are non-blocking operations since it is undesirable to have user code lock the access of a kernel code. In multi-threaded scenarios, if a user forces other users or the kernel to be placed into a wait state until the user releases a lock, then a performance and security issue may occur. The performance of the multi-threaded operation may be reduced because one or more processes may be in wait states when blocking operations are used. The reliability of the system may be compromised if the kernel-mode code indefinitely waits for user-mode code. Accordingly, non-blocking operations are preferred in the present invention.

In another aspect of the invention, synchronization between the user mode and the kernel mode is enhanced because the operating system kernel, which posts messages to the completion list, guarantees correct memory ordering to make sure that message meta-data and data are made visible to the user-mode in a proper and deterministic order. In another aspect of synchronization, all kernel mode accesses to the completion list are performed using the system virtual addresses in coordination with the memory manager to maintain proper reference counts to the physical pages containing the completion list. Thus, a user-mode un-mapping or freeing-up of an active completion list will not crash the system since the kernel mode acquires an active reference to the pages when they were probed, locked, and mapped to system range when the completion list was registered on the system. In another aspect, the kernel mode code performs all necessary checks when accessing completion list structures to make sure that a corrupted completion list will not crash the system. For example, entry indices in the list 320 are checked to make sure that they reference messages in the data field 340 that are in an address range defined by the bounds of the data structure 300.

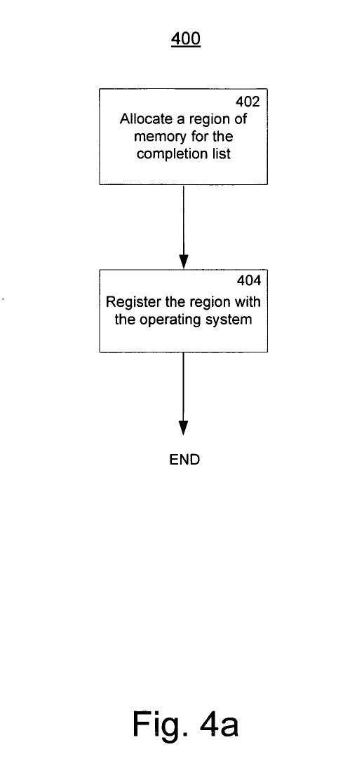

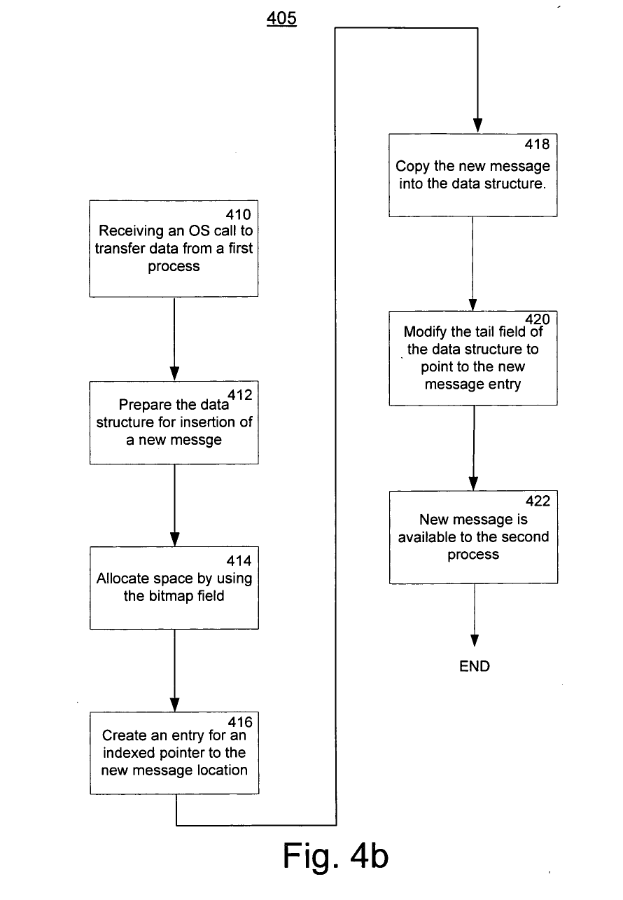

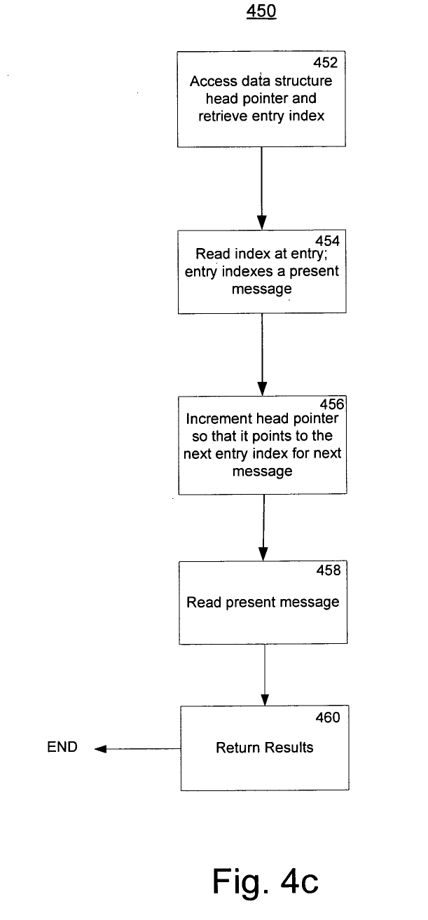

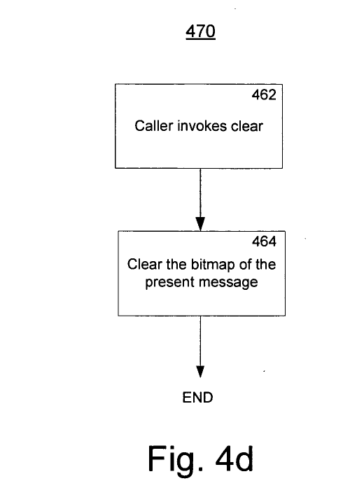

FIG. 4a depicts an example registration method 400 according to aspects of the invention. Registration is generally user mode initiated. In the specific example of method 400, a user may invoke this high-speed transfer mechanism to receive messages. A user mode process initiates a registration by allocating a region of memory that it wishes to use for the completion list (step 402). The defined region of memory is then registered with the operating system (step 404) so that messages can be delivered to the completion list.

FIG. 4b depicts an example method 400 according aspects of the invention. The method involves the transfer (insertion) of a message from a first process to a second process via a message-passing data structure 300. Using the method 400, a transmission from a first process to a second process may be conducted one or more times. Initially, the transmitting process, the first process, loads a register or buffer with a message to be transferred. Then, the operating system kernel receives a system call to execute the transfer (step 410). The operating system kernel begins preparation of the message-passing data structure 300 for insertion of the new message (step 412). The kernel examines the message-passing data structure 300 and reads the bitmap field 330 to allocate space for the new message (step 414). This step is performed to avoid overwriting an existing un-read message in the message data field 340. It claims a section of the data region by setting bits in the bitmap field corresponding to the size of the message.

A new entry is then created for an index in the list field 320 (step 416). The new entry is created having a fixed size index which references a location of the beginning a the new message in the data field 340. After the index entry is created, the new message is copied (step 418) into the data field 340 of the message-passing data structure 300 from the first process buffer. As an aspect of the invention, this is the only copy needed in the transfer of the new message from the first process to the second process. The tail field 314 of the header 310 in the message-passing data structure 300 is modified (step 420) to point to the new message entry field. This is performed because the new message is the last message that has been added to the data structure and the tail field is an indication of which message is the last added message.

According to an aspect of the invention, after the tail portion is modified, the new message is available to the second process (step 422). As a result the second process can read the new message directly out of the data structure. Using the head and tail fields of the header 310, the second process gains access to the new entry relating to the new message and can read the new message without a system service call to the kernel. The read of the new message by the second process is also performed without an additional copy operation by the second process because the data structure 300 with the new message is mapped into the address space accessible to the second process.

FIG. 4c depicts a process 450 by which messages are removed from the data structure 300. With a message-passing data structure loaded with multiple messages, the second or receiving process can access the data structure (step 452) head pointer 312 and retrieve the indicated entry pointer on the list field 320. At the entry in the list field 320, the index of the entry is read (step 454). This index points to the message that is the first message to be read, a present message. As an aspect of the message-passing data structure 300, the entry index of the list field 320 references a present message in the data field 340.

After the entry field is accessed and the present message location is known, the head pointer is incremented (step 456) so that it points to the next entry in the list field 320. Thus, the head pointer references the next message to be read by the second process. As an aspect of the invention, the return value is a pointer to the new message or the Null value of the list is empty. The present message may then be read by the second process (step 458).

FIG. 4d depicts a process 470 associated with the current invention. As a separate operation, a caller invokes a clearing operation when the receiving process no longer needs the received message (step 462), it clears the bitmap of the present message (step 464) by invoking an API to free the message. This is necessary to allow the space occupied by the message to be reused for messages inserted into the completion list later.

In one aspect of the invention, the completion list may be used in an outbox mode as previously discussed. The outbox mode is generally requested by the message sending side and the operation is transparent to the receiver side. As with the inbox, multiple threads may utilize a completion list configured as an outbox. The threads executing in the process that owns the completion list can directly access the completion list outbox. As with the inbox, outboxes, upon generation, are registered with the operating system. In use, the outbox messages are removed by the kernel to process them for delivery and the outbox may be cleared by the kernel after reading from the outbox.

Exemplary Computing Device

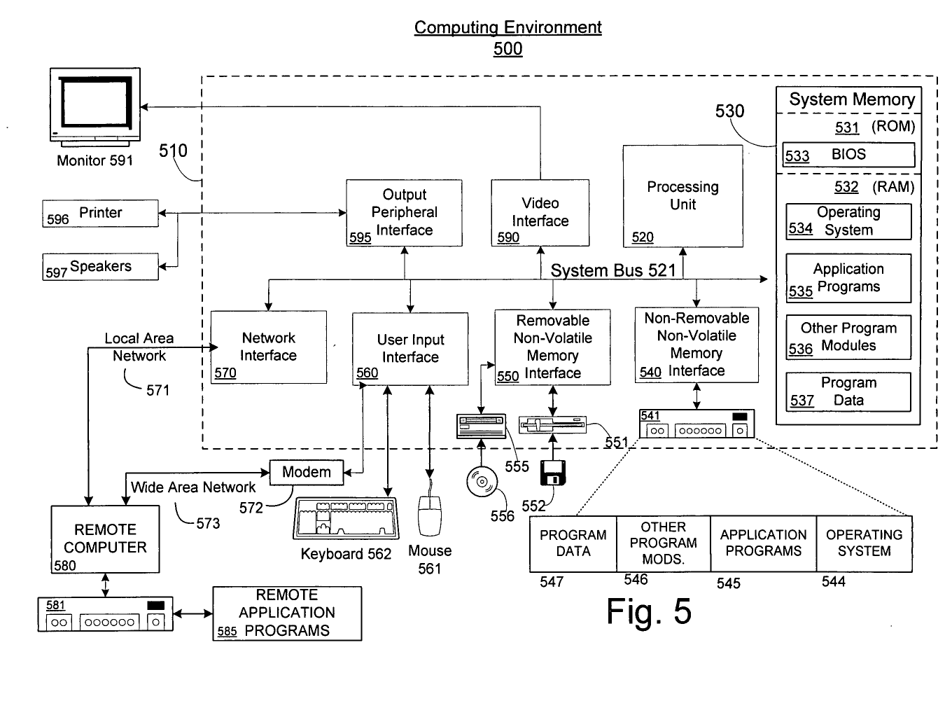

FIG. 5 and the following discussion are intended to provide a brief general description of a suitable computing environment in which embodiments of the invention may be implemented. While a general purpose computer is described below, this is but one single processor example, and embodiments of the invention with multiple processors may be implemented with other computing devices, such as a client having network/bus interoperability and interaction. Thus, embodiments of the invention may be implemented in an environment of networked hosted services in which very little or minimal client resources are implicated, e.g., a networked environment in which the client device serves merely as an interface to the network/bus, such as an object placed in an appliance, or other computing devices and objects as well. In essence, anywhere that data may be stored or from which data may be retrieved is a desirable, or suitable, environment for operation.

Although not required, embodiments of the invention can also be implemented via an operating system, for use by a developer of services for a device or object, and/or included within application software. Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that various embodiments of the invention may be practiced with other computer configurations. Other well known computing systems, environments, and/or configurations that may be suitable for use include, but are not limited to, personal computers (PCs), automated teller machines, server computers, hand-held or laptop devices, multi-processor systems, microprocessor-based systems, programmable consumer electronics, network PCs, appliances, lights, environmental control elements, minicomputers, mainframe computers and the like. Embodiments of the invention may also be practiced in distributed computing environments where tasks are performed by remote processing devices that are linked through a communications network/bus or other data transmission medium. In a distributed computing environment, program modules may be located in both local and remote computer storage media including memory storage devices and client nodes may in turn behave as server nodes.

FIG. 5 thus illustrates an example of a suitable computing system environment 500 in which the embodiments of the invention may be implemented, although as made clear above, the computing system environment 500 is only one example of a suitable computing environment and is not intended to suggest any limitation as to the scope of use or functionality of an embodiment of the invention. Neither should the computing environment 500 be interpreted as having any dependency or requirement relating to any one or combination of components illustrated in the exemplary operating environment 500.

With reference to FIG. 5, an exemplary system for implementing an embodiment of the invention includes a general purpose computing device in the form of a computer system 510. Components of computer system 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer system 510 typically includes a variety of computer readable media. Computer readable media can be any available media that can be accessed by computer system 510 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, Random Access Memory (RAM), Read Only Memory (ROM), Electrically Erasable Programmable Read Only Memory (EEPROM), flash memory or other memory technology, Compact Disk Read Only Memory (CDROM), compact disc-rewritable (CDRW), digital versatile disks (DVD) or other optical disk storage, magnetic cassettes, magnetic tape, magnetic disk storage or other magnetic storage devices, or any other medium which can be used to store the desired information and which can accessed by computer system 510. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer system 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536, and program data 537.

The computer system 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556, such as a CD ROM, CDRW, DVD, or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media discussed above and illustrated in FIG. 5 provide storage of computer readable instructions, data structures, program modules and other data for the computer system 510. In FIG. 5, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that, at a minimum, they are different copies. A user may enter commands and information into the computer system 510 through input devices such as a keyboard 562 and pointing device 561, commonly referred to as a mouse, trackball or touch pad. Other input devices (not shown) may include a microphone, joystick, game pad, satellite dish, scanner, or the like. These and other input devices are often connected to the processing unit 520 through a user input interface 560 that is coupled to the system bus 521, but may be connected by other interface and bus structures, such as a parallel port, game port or a universal serial bus (USB). A monitor 591 or other type of display device is also connected to the system bus 521 via an interface, such as a video interface 590, which may in turn communicate with video memory (not shown). In addition to monitor 591, computer systems may also include other peripheral output devices such as speakers 597 and printer 596, which may be connected through an output peripheral interface 595.

The computer system 510 may operate in a networked or distributed environment using logical connections to one or more remote computers, such as a remote computer 580. The remote computer 580 may be a personal computer, a server, a router, a network PC, a peer device or other common network node, and typically includes many or all of the elements described above relative to the computer system 510, although only a memory storage device 581 has been illustrated in FIG. 5. The logical connections depicted in FIG. 5 include a local area network (LAN) 571 and a wide area network (WAN) 573, but may also include other networks/buses. Such networking environments are commonplace in homes, offices, enterprise-wide computer networks, intranets and the Internet.

When used in a LAN networking environment, the computer system 510 is connected to the LAN 571 through a network interface or adapter 570. When used in a WAN networking environment, the computer system 510 typically includes a modem 572 or other means for establishing communications over the WAN 573, such as the Internet. The modem 572, which may be internal or external, may be connected to the system bus 521 via the user input interface 560, or other appropriate mechanism. In a networked environment, program modules depicted relative to the computer system 510, or portions thereof, may be stored in the remote memory storage device. By way of example, and not limitation, FIG. 5 illustrates remote application programs 585 as residing on memory device 581. It will be appreciated that the network connections shown are exemplary and other means of establishing a communications link between the computers may be used.

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT®'s .NET™ platform, available from Microsoft Corporation, includes servers, building-block services, such as Web-based data storage, and downloadable device software. While exemplary embodiments herein are described in connection with software residing on a computing device, one or more portions of an embodiment of the invention may also be implemented via an operating system, application programming interface (API) or a “middle man” object between any of a coprocessor, a display device and a requesting object, such that operation may be performed by, supported in or accessed via all of .NET™'s languages and services, and in other distributed computing frameworks as well.

As mentioned above, while exemplary embodiments of the invention have been described in connection with various computing devices and network architectures, the underlying concepts may be applied to any computing device or system in which it is desirable to implement a method to transfer a message from one software process to another software process. Thus, the methods and systems described in connection with embodiments of the present invention may be applied to a variety of applications and devices. While exemplary programming languages, names and examples are chosen herein as representative of various choices, these languages, names and examples are not intended to be limiting. One of ordinary skill in the art will appreciate that there are numerous ways of providing object code that achieves the same, similar or equivalent systems and methods achieved by embodiments of the invention.

The various techniques described herein may be implemented in connection with hardware or software or, where appropriate, with a combination of both. Thus, the methods and apparatus of the invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the signal processing services of an embodiment of the present invention, e.g., through the use of a data processing API or the like, are preferably implemented in a high level procedural or object oriented programming language to communicate with a computer. However, the program(s) can be implemented in assembly or machine language, if desired. In any case, the language may be a compiled or interpreted language, and combined with hardware implementations.

While aspects of the present invention has been described in connection with the preferred embodiments of the various figures, it is to be understood that other similar embodiments may be used or modifications and additions may be made to the described embodiment for performing the same function of the present invention without deviating therefrom. Furthermore, it should be emphasized that a variety of computer platforms, including handheld device operating systems and other application specific operating systems are contemplated, especially as the number of wireless networked devices continues to proliferate. Therefore, the claimed invention should not be limited to any single embodiment, but rather should be construed in breadth and scope in accordance with the appended claims.

What is claimed:

1. A computer readable medium having stored thereon a data structure, the data structure useful to transfer messages between software processes in a computer, the data structure comprising:
a header field comprising data indicative of a head pointer and a tail pointer indicating a first location and a last location respectively for list items;
a list field comprising a plurality of entries, each entry comprising an index for a message, wherein pointers in the header field reference the entries in the list field;
a data field comprising a plurality of messages, messages in the data field being referenced by indexes of the entries in the list field; and
a bitmap field comprising an indication of the area used by each message in the data field; wherein the bitmap defines the space available in the data field for new message insertion, and wherein the data structure is maintained by an operating system kernel and enables the passing of one or more messages from a first computer process to a second computer process wherein the second computer process can access a passed message without performing a system call to the operating system kernel.

2. The data structure of claim 1, wherein the list field comprising a plurality of fixed size entries.

3. The data structure of claim 1, wherein the data field comprises messages of different length and wherein the bitmap field indicates each message size.

4. A method of passing a first message from a first software process to a second software process using a message-passing data structure mapped to an operating system kernel and the second software process, the method comprising:
receiving an operating system call from the first process to transfer a first message to the second process, the first process having a different address space than the second process;
configuring the message-passing data structure to accept the first message, the second process previously registering the message-passing data structure with the operating system kernel;
copying the first message to a message-passing data structure maintained by the operating system kernel, wherein copying the first message into the message-passing data structure makes the first message available in the address space of the second process and avoids a system call to the operating system kernel by the second process to acquire the first message.

5. The method of claim 4, wherein receiving an operating system call from the first process to transfer a first message to the second process comprises receiving an operating system kernel call to transfer the first message from a send buffer of the first process to the message-passing data structure.

6. The method of claim 4, wherein configuring the message-passing data structure to accept the first message comprises:
allocating space for a first message to be passed from the first process to the second process by modifying a bitmap of messages in the message-passing data structure, the bitmap indicating the location of messages in the data structure;
creating an indexed pointer for the first message, the indexed pointer indicating a location of the first message in the data structure.

7. The method of claim 4, wherein copying the first message to a message-passing data structure maintained by the operating system kernel comprises:
copying the first message data from the first process into a data portion of the message-passing data structure; and
modifying a tail field of a header portion of the message-passing data structure, the tail field comprising a reference to the indexed pointer, wherein the first message becomes visible to the second process after the tail field is modified.

8. The method of claim 4, further comprising:
clearing the bitmap of the first message initiated by the second process after the second process has finished using the first message.

9. The method of claim 4, further comprising:
accessing a second message by the second process using the message-passing data structure.

10. The method of claim 9, wherein accessing a second message by the second process comprises:
incrementing a head field of a header portion of the message-passing data structure, the head field comprising a pointer to an indexed pointer, wherein the second message can be retrieved at the next remove operation after the head field is incremented.

11. A computer-readable medium having computer-executable instructions for performing a method of transferring messages in a computer, the method comprising:
registering a message-passing data structure with an operating system kernel;
receiving an operating system call from a first process to transfer a first message to a second process, the first process having a different address space than the second process;
configuring the message-passing data structure to accept the first message, the message-passing data structure comprising a header field, a list field, a message field and a bitmap, the configuring comprising:
allocating space in the message-passing data structure for the first message by modifying the bitmap, the bitmap indicating the location of messages in the data structure; and
modifying the list field by creating an indexed pointer for the first message, the indexed pointer indicating a location of the first message;
copying the first message data from the first process into a data portion of the message-passing data structure; and
modifying a tail field of a header portion of the message-passing data structure, the tail field comprising a reference to the indexed pointer, wherein the first message becomes visible to the second process after the tail field is modified;
wherein copying the first message into the message-passing data structure makes the first message available in the address space of the second process and avoids a system call to the operating system kernel by the second process to acquire the first message.

12. The computer-readable medium of claim 11, wherein the step of registering a message-passing data structure with an operating system kernel comprises registering the message-passing data structure as one of the group consisting of an inbox and an outbox.

13. The computer-readable medium of claim 11, wherein the step of receiving an operating system call from a first process to transfer a first message to a second process comprises receiving an operating system kernel call to transfer the first message from a send buffer of the first process to the message-passing data structure.

14. The computer-readable medium of claim 11, further comprising:
clearing the bitmap of the first message after the second process has finished using the first message.

15. The computer-readable medium of claim 11, further comprising:
accessing a second message by the second process using the message-passing data structure.

16. The computer-readable medium of claim 15, wherein accessing a second message by the second process comprises:
incrementing a head field of a header portion of the message-passing data structure, the head field comprising a pointer to an indexed pointer, wherein the second message can be retrieved at the next remove operation after the head field is incremented.

17. The computer-readable medium of claim 11, wherein the step of registering a message-passing data structure with an operating system kernel comprises registering a first message-passing data structure as an inbox and registering a second message-passing data structure as an outbox.

18. The computer-readable medium of claim 11, wherein the step of registering a message-passing data structure with an operating system kernel comprises registering a first message-passing data structure as an inbox wherein multiple processes may transfer a message into the message-passing data structure to be received by the second process.
